(19) United States
(12) Patent Application Publication
(10) Pub. No.: US 2009/0076947 A1
(43) Pub. Date: Mar. 19, 2009

(54) Universal Last Call

(76) Inventor: William W. Lange, Corona del Mar, CA (US)

Correspondence Address: WILSON DANIEL SWAYZE, JR., 3804 CLEARWATER CT., PLANO, TX, 75025, US

(21) Appl. No.: 12/275,277

(22) Filed: Nov. 21, 2008

Related U.S. Application Data
(63) Continuation-in-part of application No. 11/088,059, filed on Mar. 23, 2005.

(51) Int. Cl. G06Q 40/00

(52) U.S. Cl. 705/37

(57) ABSTRACT

A method of advertising, marketing, and auction sale of real estate properties and more particularly a method of handling last minute online bidding extensions are described. An Internet website has been designed for this purpose such that prospective customers or interested bidders may view property specific photographs and other details with respect to the property on property profile pages. In the electronic bidding format, as long as at least one bid is made within an established bid period before the deadline, the bidding can be extended for a pre-determined amount of time.

### CROSS REFERENCE TO RELATED APPLICATIONS

The present application is a continuation in part of United States patent application having a Ser. No. 11/088,059 which was filed on Mar. 23, 2005.

### FIELD OF THE INVENTION

The present invention relates to a method of advertising, marketing and auctioning real estate properties, and more particularly to a method of handling last minute online bidding extensions.

### BACKGROUND OF THE INVENTION

The auction process is both a well-established and tested method of conducting business. Today, auctions have become one of the most popular methods of marketing and selling goods and services. Various buyers and sellers have utilized numerous variations on how auctions are conducted. These various auctioning techniques, including in-person, closed, English, increasing and the like, are typically tailored to suit the requirements of both buyers and sellers.

In order to sell real estate by auction, bidders typically had to be physically present. This puts geographically distant bidders at a disadvantage. Various methods have been suggested and are used in which auctions are held over the Internet to overcome this disadvantage.

Problems associated with real estate bidding and auction methods known in the prior art have left room for improvement however. One problem associated with Internet or “on-line” auctioning is premature bidding closure. In an in-person auction, bidding activity tends to increase as the scheduled bidding deadline approaches. Generally, it is possible to achieve a better auction price if the auction is allowed to continue as long as bids continue to come in. Typically, this goal can be achieved using an “overtime,” wherein the closing time for a specific lot is automatically extended based on the rate of bids continuing to flow into the auction. Overtimes discourage bidders from submitting last minute bids in an attempt to overcome a competitive reaction from other bidders.

Bidding at auction is an unpredictable event. A final bid price is affected by many factors most of which are not controlled by the bidder. The final bid price may depend on the other bidders which are currently interested in the lot being bid on. The presence or absence of one particular bidder may significantly affect the outcome of the auction. The final bid price may depend on economic circumstances, and may be affected by unforeseen circumstances such as a stock market sell off.

Many times, a bidder is interested in several lots that are somewhat homogeneous or interchangeable in nature or location, for example, houses in a particular neighborhood or town. It is then possible to develop a category that would encompass the lots which are homogeneous or interchangeable in nature or location. These lots for a given category may be auctioned in a dynamic manner. A first lot may come up for bidding for a first predetermined time period while a second lot may be offered for bidding for a second predetermined time period. In those cases, the first predetermined time period does not end at the same time as the second predetermined time period.

A bidder is forced to make choices on which lot to buy. At any given time, there may be several desirable lots which may interest the buyer. Typically, the bidding for these lots does not expire at a single time. Consequently, the bidder does not know what the price will be for a lot that expires in the future. The bidder may be interested in a first lot which expires at a first time and a second lot which expires at a second time which may be after the first time.

The bidder may find the second lot more desirable than the first lot but because the bidding for the second lot has not expired, there is uncertainty as to the price for the second lot. The bidder may successfully purchase the first lot only to find that the bidder could have purchased the second lot for a better price or value. Alternatively, the bidder may allow the first lot to be purchased by someone else only to find that the second lot was bid to a higher price by other bidders than the bidder was willing or able to pay. Under these circumstances, the bidder may wish that he had purchased the first lot because now the bidder has not purchased either the first lot or the second lot.

An example of supplier side bidding overtime can be found in U.S. Pat. Nos. 6,216,114, 6,223,167, and 6,499,018 to Alaia et al. These patents disclose an auctioning method with flexible overtime periods. These inventions are designed to stop online bidding in the event of a computer or other problem, hold the auction in “pending” status, and then increase the length of the auction by the corresponding amount of time in a multiple seller reverse-bidding type of auction.

U.S. Pat. App. No. 20040039680 to Markus et al. describes a reverse electronic auctioning method wherein sellers bid to a single buyer. This patent discloses a type of auction wherein bidders are notified of a remaining time interval when the remaining auction time is less than, or equal to the remaining time interval. An extension can then be carried out for the comparison of bids. Although Markus and the Alaia patents disclose an overtime concept, they are different from the embodiment of the present invention.

In the present invention, overtime functions are automatically accomplished. When an online auction bid is submitted within a previously disclosed time period prior to the established bid deadline, the bid deadline is extended for a like time period. This object of the invention can be colloquially referred to as called “Last Call.”

It is a object of the present invention to provide a method of advertising, marketing, and auctioning real estate properties and chattel property, wherein said auctioning can be conducted in sealed or live electronic bid formats. Another object of the invention is to provide a method of advertising, marketing, and auctioning real estate properties and chattel property to provide a method of handling last minute online bidding extensions.

A further object of the invention is to provide an Internet web site dedicated to advertising, marketing, and auctioning real estate property and chattel property wherein interested bidders may log in, view and download specific property information such as photographs, maps, government reports, tax information, and plot plans. They may then obtain property specific financing information by viewing a web page dedicated to each individual property, wherein such property profile pages contain all the information necessary for an interested party to become familiar with the property and to place a sealed or electronic, online bid to purchase the property.

A further object of the invention is to provide a password protected area on the web site, called private auction events, where potential bidders may only view the above described property information and place property bids by invitation of the seller or the seller's agent.

### SUMMARY

The present invention relates to a method of advertising, marketing, and auctioning real estate properties and chattel property and more particularly to a method of handling last minute online bidding extensions.

An Internet website is used as an auction forum dedicated to advertising, marketing, and auctioning real estate, and contains details on properties for sale in the United States and throughout the world. Real estate and chattel property owners may post a property for sale on the site. The site then advertises individual properties for sale in a wide variety of media. Individual media outlets are each assigned an individual media code.

Each advertisement contains a unique uniform resource locator address (URL), which specifies the particular property for sale, and the media code associated with that advertisement. By typing in the Internet address contained in an advertisement, a potential bidder is directed to a property profile page on the auction website. In addition, the auction website records the media code associated with the advertisement.

The website then generates a media tracking report to gauge the efficacy of a particular advertisement against others. The website can then attach a cost per response valuation to every type of advertising in an auction marketing campaign. Advertisements that are inexpensive and generate a large number of potential bidders can be preferred over advertisements that generate little interest. In addition, a cost per respondent value can be tracked through the auction process.

When an auction begins, interested bidders may view photographs and download specific information about the property including maps, government reports, tax information, plot plans and financing information. This information may be obtained by viewing a property profile web page dedicated to each individual property (property profile page). Each property profile page contains a specific bidding deadline when all the bidding for that specific property shall cease.

The auctioning method of the present invention can be conducted in sealed or live electronic bidding formats. Regardless of the bidding format, a bid deadline is used to stop bidding at the end of an auction. No bids are accepted after the published bid deadline. However, in the electronic format, if a bid is submitted during a pre-defined period before the bidding deadline, the deadline is extended for another pre-defined period. This extension of time is designated a “last call.” The new bid deadline will continue to be extended in this manner until no new valid bids are received within the predefined time period before the bid deadline. When no more bids have been submitted in a “last call” period, the bidding is closed and the property in question awarded to the highest qualified bidder.

A method for extending the deadline for bids of a plurality of lots which correspond to property in an auction may include establishing a category for the lots to be auctioned, selecting the lots which meet the criterion of the category for the lots to be auctioned, determining the latest ending time from the lots which meet the criteria of the category, and extending the end time of all the lots to be substantially the latest ending time which had been determined.

The method further may include the step of auctioning the lots in accordance with the extended end time, and the lots may correspond to chattel property.

The lots may correspond to real estate property, and the bids for the auction mar be in sealed format.

The bids for the auction may be in the electronic format, and the category may correspond to a price range.

The category may correspond to a geographical area, and the category may correspond to a neighborhood school.

The category may correspond to the type of real estate, and the real estate may correspond to housing real estate.

The real estate may correspond to business real estate; and the category may correspond to the age of the real estate.

The real estate may correspond to housing real estate, and the real estate may correspond to business real estate.

### BRIEF DESCRIPTION OF THE FIGURES

FIG. 1 is an illustration of a web page of current auction events, displaying a multitude of auction properties (or chattel property). Potential bidders selecting a group of properties or an individual property are directed to a property portfolio page if the event contains more than one property or to a property profile page if the event contains a single property.

FIG. 2 is an illustration of a web page displaying a portfolio of current auction events grouped around a single seller or other common feature. Potential bidders selecting an individual property from this portfolio page are directed to its property profile page.

FIG. 3 is an illustration of a property profile page where a property is being auctioned in a sealed bid format wherein the details of a property for sale are disclosed without revealing any bidder identity, bid amount or bid history.

FIG. 4 is an illustration of a property profile page where a property is being auctioned in an online format wherein the details of a property for sale and bidder identities, bid amounts and the bid history are disclosed.

FIG. 5 illustrates an example of extending the bidding deadline;

FIG. 6 illustrates the rate of bids and the predetermined threshold value for determining whether to extend the bidding deadline;

FIG. 7 illustrates another bidding deadline where the bidding deadline is not extended;

FIG. 8 illustrates the rate of bids and the predetermined threshold value for determining whether to extend the bidding deadline;

FIG. 9 illustrates the start and end times for the bidding for four different lots;

FIG. 10 illustrates the adjusted start and end times for bidding for four different lots;

FIG. 11 illustrates the steps of the present invention.

### DESCRIPTION

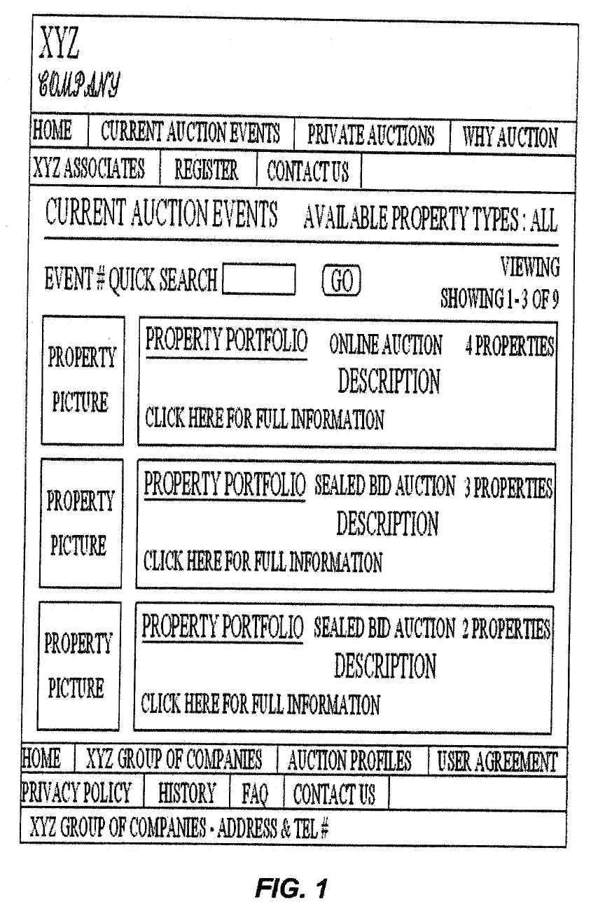

The embodiments of the present invention are illustrated by way of demonstration web pages as shown in FIGS. 1 through 4.

FIG. 1 shows a web page displaying brief descriptions of current auction events. An auction event may include multiple properties or it may include a single property. The auction event may be for chattel property as well as real estate, and the teachings of the present invention are equally applicable to both chattel property and real estate property.

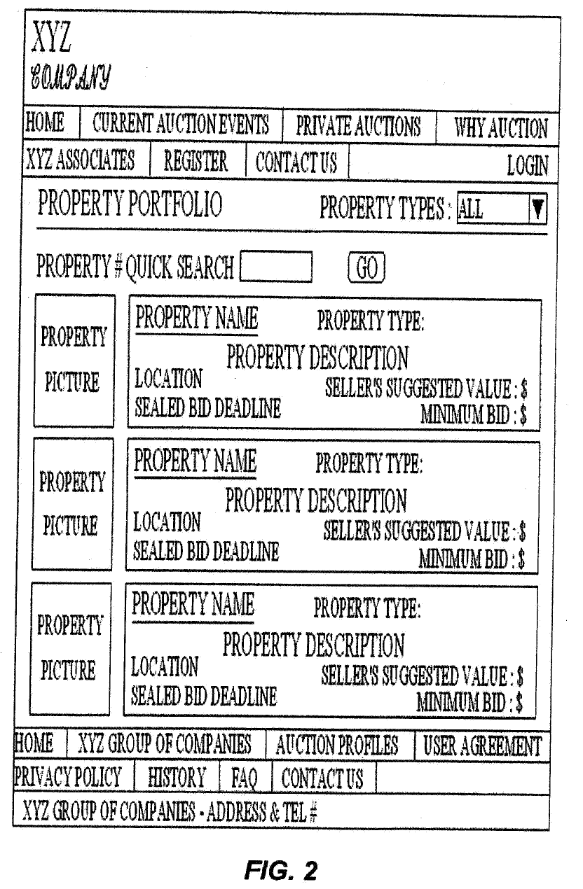

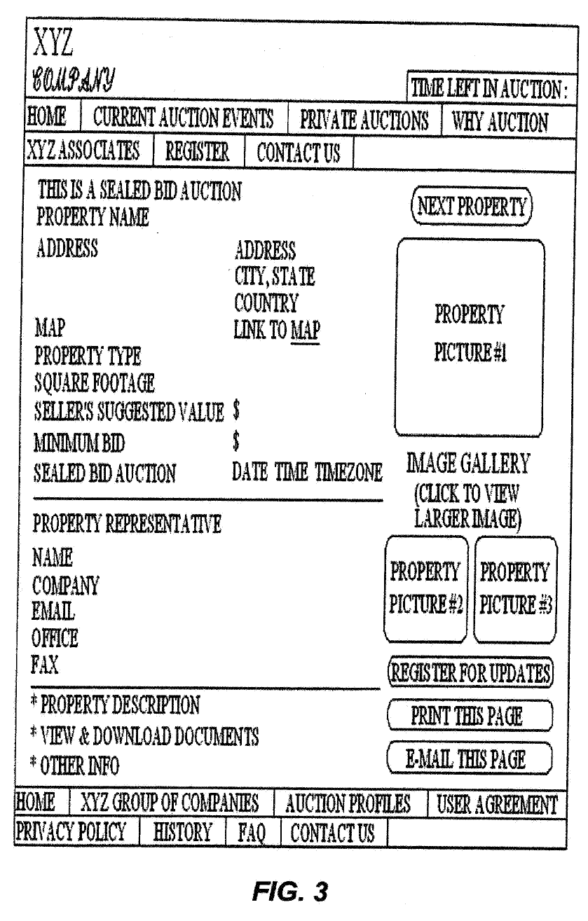

If an auction event includes multiple properties, a description of the various properties including their general locations, property types and sizes and various other information is displayed. A single picture of one of the properties or chattel property is also displayed. By clicking on the picture or the general property description, the potential bidder is taken to the property portfolio page described in FIG. 2. If the auction event includes a single property or chattel property, a description of that property including its picture, location, size and various other information is displayed. If the property is chattel property, then the attributes of the chattel property is displayed. By clicking on the picture or the property description, the potential bidder is taken directly to the property profile page as described in FIGS. 3 & 4.

The current auction events page also includes a search tool which allows potential bidders to find a specific property or groups of properties of interest by using various filters such as location, type, size and value. The search tool may be used to find specific chattel property based on the attributes of the chattel. From the current auction events page, a potential bidder can navigate to any of the sealed bid or online auctions on the web site.

FIG. 2 illustrates a portfolio of properties associated with a single seller or other common feature. This is known as the property portfolio page. When multiple properties are owned by a single entity, or have another similar common features, it is appropriate to group them in a portfolio subcategory since potential buyers may have an interest in properties according to their common features. A similar procedure can be implemented for chattel property. The property portfolio page also includes a search tool which allows potential bidders to find specific properties of interest by using various filters such as location, type and price. By selecting an individual property from the portfolio page, prospective bidders are directed to its property profile page.

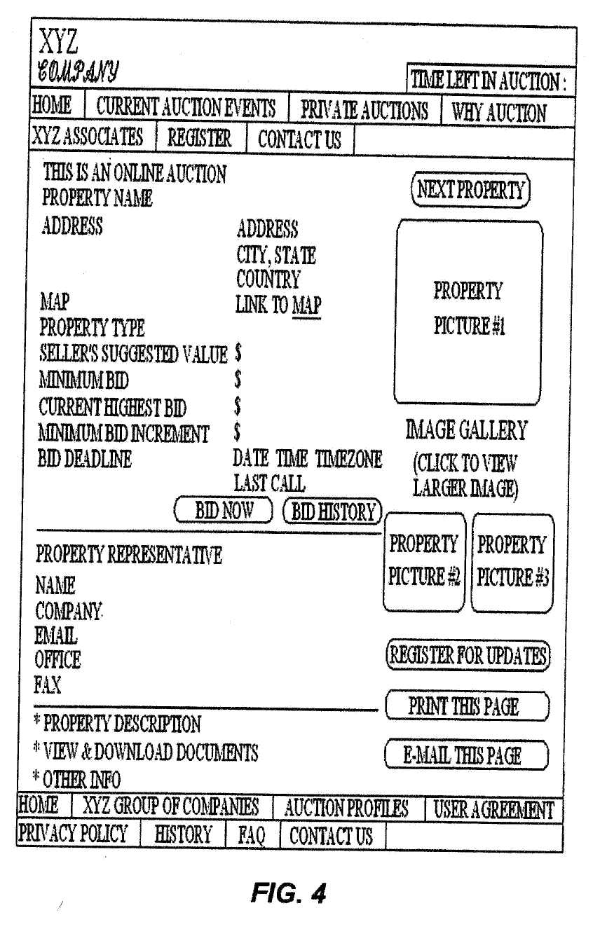

FIGS. 3 and 4 show individual properties on a part of the website known as a “property profile page.” The same procedures are applicable to chattel property. Each property has its own unique property profile page. Property profile pages disclose a particular real estate property or chattel property slated for auction and information regarding the property. Interested bidders may view photographs and download information on a particular property or chattel property including maps, government reports, tax information, plot plans and obtain financing information by viewing the particular property profile page. Interested bidders who have not registered under the website are requested to register by completing a brief data sheet. Once they have registered, they may log-in with a specific username and password and view or download documents related to the property or chattel property in question. Other information, such as the minimum bid increment, bid deadline, contact information of the property representative who is responsible for conducting tours and viewing of that specific property, and other detailed information on the property can be found on individual property profile pages.

Property portfolio and property profile pages can also be accessed directly from the URL address listed in various print and electronic advertisements. When a property, chattel property or group of properties is advertised for sale, the advertisement contains a URL that will direct an interested party directly to a property portfolio page in the event multiple properties are being advertised and to a property profile page in the event a single property is being advertised. Information is imbedded in the URL regarding the auction property or auction chattel property and the media that published the advertisement. The website assimilates information regarding the number of times a particular URL is accessed or “hit” and generates a media tracking report.

The media tracking report compares the price of an advertisement with the number of “hits” resulting from that advertisement. It also records information about bidders that have signed in from a particular advertisement; whether they are principles or brokers. In this manner, the website is able to assign a cost per respondent value to individual media. In the case where respondents register on the website, the cost per respondent value can then be analyzed through the several stages of the auction process.

The stages may be defined as seven tracking milestones and may include:

1. Prospect ‘Hit’ to website.

### 2. Prospect Registration.

3. Registrant visitation to Property.
4. Registrant prequalifies for mortgage financing (residential Website only).
5. Bidder places Sealed Bid and submits same along with a Bid Deposit.
6. Bidder places Online Bid (only if the sale progresses from the sealed bid format to the online bid format).

### 7. Winning Bidder.

For instance: If an advertisement costs $6000 and receives 600 responses, each response is valued at $10. If 60 of the 600 responses register on the website, each registration is valued at $100. If 6 of the 60 registrations, bid on a property, each bid is valued at $1000, and if 1 of those six is the winning bidder, they are valued at $6000. By employing this method, the website can quickly determine the cost effectiveness of a particular advertisement, and can amend future media schedules in response.

In order to submit an initial sealed bid or place a subsequent online electronic bid, interested bidders must first register on the website. A written or a sealed bid must be submitted to the seller's agent on or before the bid deadline by utilizing the approved bid form, which can be downloaded from the property profile page. The completed bid form can then be sent or delivered to the seller's agent. Additionally, the bid must be at or above the amount established by the seller as the lowest allowable bid (minimum bid) as set forth on the property profile page.

When submitting the bid form, interested bidders must include a bid deposit in the form of a deposit payment. For example, a bid deposit might be the highest of $30,000, or two percent (2%) of the amount of the bid. A winning bidder's deposit is credited toward the purchase price of the property. For all unsuccessful bidders, the bid deposit is returned either in full or less a nominal escrow fee within a designated period from the time a winning bidder is determined.

The seller retains the right to change the auction format from a sealed bid auction to a live online electronic auction at any time. A sealed bid auction format can be seen in FIG. 3. During a sealed bid format, the details of a property for sale are disclosed without revealing any bidder identity, bid amounts or bid history. Upon declaring an online auction, all interested bidders or parties are allowed to view the amount of the highest sealed bid by means of a bid history update located on the property profile page. Once the bidding format has moved from sealed bid to online bid, potential bidders who have not previously submitted a bid may still do so provided they submit their initial bid on a bid form and submit it to the seller's agent along with the required bid deposit.

Each time a new electronic bid is placed during an online auction, the bidder's identity, the amount of the bid, and the date and time that the bid was received by the website is published in the bid history section. All bidders and other interested parties are encouraged to frequently review the bid history during the online auction in order to receive updates on the highest bid. No additional bid deposit is required when placing subsequent bids during an online auction.

Upon declaring an online auction, electronic bids may be tendered up to the bid deadline using a bid button on the property profile page. Bids may be tendered up to the bid deadline subject to a possible Last Call extension as described below. If no bid is submitted within the designated period of time (usually, but not limited to 24 hours) prior to the published bid deadline, the bidding will be closed. It should be noted that access to the bid history section is only available from the property profile page after an online auction has been declared.

If an online auction bid or a predetermined threshold number of auction bids is submitted within a pre-determined time before the published bid deadline, the deadline will be extended for another pre-determined period of time, which will be referred to as “Last Call.” In the event another new bid or a predetermined threshold number of bids is received before the new bid deadline, the deadline will again be extended for an additional pre-determined period. The new bid deadline will continue to be extended in this manner until no new valid bid is received prior to the bid deadline. When no new valid bid is received, the bidding will be closed.

For Example, if a published online auction bid deadline is initially set for Apr. 22, 2005 at 17:00, and a new bid is submitted on Apr. 22, 2005 at 11:02, then the new bid deadline will be extended to Apr. 23, 2005 at 17:00, assuming that the designated time period is 24 hours. Further, if another new bid is received on Apr. 23, 2005 at 16:34, the bid deadline will once again be extended to Apr. 24, 2005 at 17:00. The new bid deadline will continue to be extended in this manner until no new bid is received within the designated period of time (e.g., 24 hours) of the bid deadline. Bidding will only be closed when no new bids are received within 24 hours of the bid deadline.

If a potential bidder has not previously submitted a bid on a property subject to a Last Call, an initial bid may still be made on the property. However, this initial bid must be delivered on a bid form along with a proper bid deposit. Each time a new bid is submitted during the Last Call, the bidder's identity, the amount of the bid, and the date and time that the bid was submitted is published in the bid history. All bidders and potential bidders will be advised to review the bid history frequently during the Last Call. It should be noted that no additional bid deposit is required when placing a bid during the Last Call.

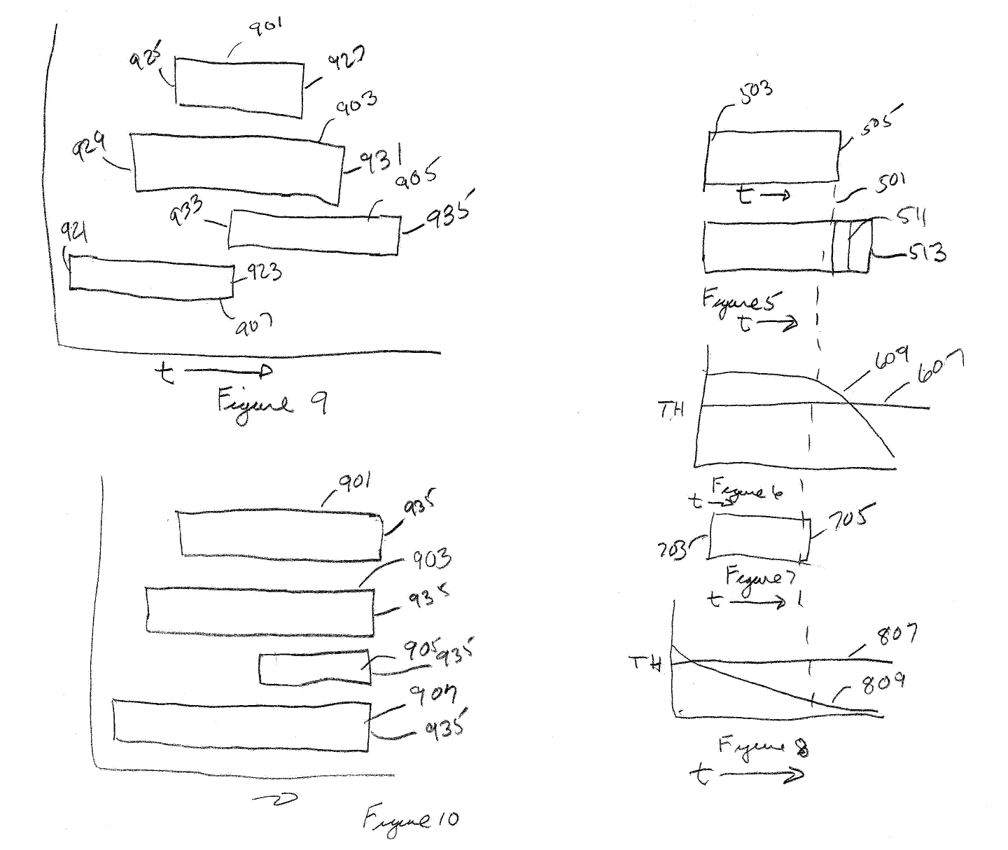

FIGS. 7 and 8 illustrate the situation when the bidding bid deadline is not extended because insufficient bidding had occurred. The bidding may be insufficient when the bidding falls below a predetermined rate of bidding or the bidding falls below one bid in a predetermined period. FIG. 7 illustrates the allowable bidding time and illustrates the start time of bidding 703 and the original bidding deadline 705. FIG. 8 illustrates a graph showing the rate of bids being received as a function of time and illustrates the predetermined threshold number 807 of bids which is required to extend the bidding deadline. The predetermined threshold number 807 may be a single bid or may be multiple bids. FIG. 8 additionally illustrates the rate of bid placement as a function of time. When bidding opens, the number of bids received exceeds the predetermined threshold number as shown by line 809. As time progresses, the rate of bids received diminishes below the predetermined threshold number so that as the original bidding deadline approaches, the number of bids 809 being received are below the predetermined threshold number 807. Consequently, the bidding deadline 705 remains the original bidding deadline with no extension.

FIG. 6 illustrates that the rate of bids received 609 exceeds the predetermined threshold number 607 at the original bidding deadline 505. Consequently, the bidding deadline is extended to a first bidding deadline 511. At the first bidding deadline 511, the rate of received bids 609 still exceeds the predetermined threshold number of bids 607 and the bidding deadline is extended to a second bidding deadline 513. As the second bidding deadline 513 is approached, the rate of received bids 609 has dropped below the predetermined threshold number 607 and the second bidding deadline 513 is not extended and the winning bid is determined at the second bidding deadline 513.

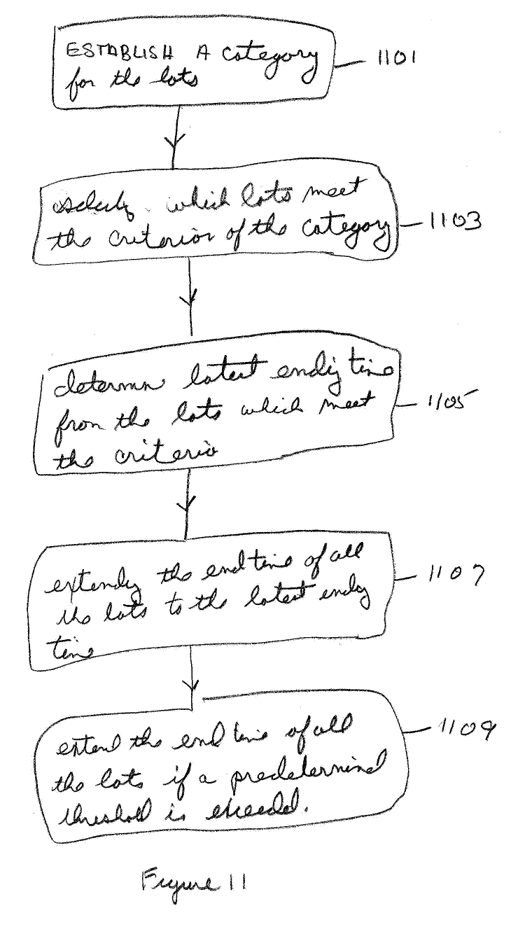

FIGS. 9 and 10 illustrate a solution to the problem of a category of lots to bid such as real estate or other chattels. Typically, these lots to be auctioned may have a start time that is typically different than any other lot to be auctioned and an end time that is typically different than any other lot to be auctioned. As discussed above because of the varying start and end times, a bidder may have to make a choice which is less than optimal. With the present invention, all of these lots of a category can have the end time of the auction adjusted to be approximately at the same time. In this manner, the bidder can intelligently choose which lot suits the bidder's needs the best based upon the choices and prices.

FIG. 9 illustrates the various lots of a given category for the lots considered which may be determined by price range, geographical area, neighborhood schools, type of house, age of the house and other factors. In this example, FIG. 9 illustrates four real estate properties having differing beginning times and end times for an auction of that respective real estate property or chattel property. For instant, the auction of the property 907 may include the earliest start time 921 and the earliest end time 923. If a bidder was interested in property 907, property 905, property 903 and property 901, the bidder would have to decide whether or not to bid on property 907, and correspondingly, the bidder would under most circumstances not be able to bid on property 905, property 903, and property 901.

The auction of property 901 has a start time 925 and an end time 927. The auction of property 901 has an end time 927 which may end before the end time 931 of the auction for the property 903 and before the end time 935 of the property 905. Consequently, the bidder would have to decide whether or not to bid on property 901, and forgo bidding on property 903 and property 905. After the end time 927 of property 901, the bidder would have given up the opportunity to bid on property 901.
The auction for the property 903 has the next earliest ending time 931, and to bid on this property 903, the bidder has lost the opportunity to bid on property 901 and property 907. Furthermore, by bidding for property 903, the bidder may lose the opportunity to bid on property 905. Finally, by bidding on property 905, the bidder has lost the opportunity to bid on property 901, property 903 and property 907. As a result the bidder may have lost a good opportunity by not bidding on any of these properties.

To aid in solving this problem, the end time for the auction for properties or chattels that have been predetermined to be of a specific classification is extended so that the end time for the auction occurs substantially simultaneously in order that the bidder can view the bids for each property or chattel and make a selection which is tailored for his desired property or chattel.

From our previous example, the property 905 has the latest ending time 935 with the auction. Consequently the ending time for the properties and 901, 903 and 907 may be extended to substantially coincide with the ending time 935 of the auction for property 905. As result the bidder can participate in all the auctions and realize the real estate property or chattel which meets his needs and desires. Furthermore, since the number of bidders for each of the real estate properties or chattels is increased, the amount bid for a given real estate property may substantially increase or the amount for all the real estate properties may substantially increase. The simultaneous adjustment of the end time for all the auctions of a category to substantially a single end time may be known as universal last call. However, it is within the scope of the present invention to incorporate the teachings of the last call with the teachings of the universal last call. More particularly, after the simultaneous adjustment of the end time for all the auctions of the category, the adjusted end time may be extended based upon the number of bids that are being placed in accordance with the teachings of last call.

FIG. 11 illustrates the steps of the method of the present invention. In step 1101, a category for the lots is established, and in step 1103, the lots are selected which meet the criteria of the category. In step 1105, the latest ending time is determined from the lots which meet the criteria, and in step 1107, the end time is extended of all the lots to the latest end time. In step 1109, the end time of all the lots is extended if a predetermined threshold of rate of bids is exceeded.

Although preferred embodiments of the present invention have been shown and described, various modifications and substitutions may be made thereto without departing from the spirit and scope of the invention. Accordingly, it is to be understood that the present invention has been described by way of illustration and not limitation.

1. A method for extending the deadline for bids of a plurality of lots which correspond to property in an auction, comprising:
establishing a category for the lots to be auctioned;
selecting the lots which meet the criterion of the category for the lots to be auctioned;
determining the latest ending time from the lots which meet the criteria of the category;
extending the end time of all the lots to be substantially the latest ending time which had been determined.

2. A method for extending the deadline for bids of a plurality of lots which correspond to property in an auction as in claim 1, the method further including the step of auctioning the lots in accordance with the extended end time.

3. A method for extending the deadline for bids of a plurality of lots which correspond to property in an auction as in claim 1, wherein the lots correspond to chattel property.

4. A method for extending the deadline for bids of a plurality of lots which correspond to property in an auction as in claim 1, wherein the lots correspond to real estate property.

5. A method for extending the deadline for bids of a plurality of lots which correspond to property in an auction as in claim 1, wherein the bids for the auction is in sealed format.

6. A method for extending the deadline for bids of a plurality of lots which correspond to property in an auction as in claim 1, wherein the bids for the auction are in the electronic format.

7. A method for extending the deadline for bids of a plurality of lots which correspond to property in an auction as in claim 1, wherein the category corresponds to a price range.

8. A method for extending the deadline for bids of a plurality of lots which correspond to property in an auction as in claim 1, wherein the category corresponds to a geographical area.

9. A method for extending the deadline for bids of a plurality of lots which correspond to property in an auction as in claim 1, wherein the category corresponds to a neighborhood school.

10. A method for extending the deadline for bids of a plurality of lots which correspond to property in an auction as in claim 1, wherein the category corresponds to the type of real estate.

11. A method for extending the deadline for bids of a plurality of lots which correspond to property in an auction as in claim 10, wherein the real estate corresponds to housing real estate.

12. A method for extending the deadline for bids of a plurality of lots which correspond to property in an auction as in claim 10, wherein the real estate corresponds to business real estate.

13. A method for extending the deadline for bids of a plurality of lots which correspond to property in an auction as in claim 1, wherein the category corresponds to the age of the real estate.

14. A method for extending the deadline for bids of a plurality of lots which correspond to property in an auction as in claim 13, wherein the real estate corresponds to housing real estate.

15. A method for extending the deadline for bids of a plurality of lots which correspond to property in an auction as in claim 13, wherein the real estate corresponds to business real estate.
